(19) United States
(12) Patent Application Publication
(10) Pub. No.: US 2008/0154992 A1
(43) Pub. Date: Jun. 26, 2008

(54) CONSTRUCTION OF A LARGE COOCURRENCE DATA FILE

(75) Inventor: Edmond Lassalle, Lannion (FR)

Correspondence Address: LOWE HAUPTMAN HAM & BERNER, LLP, 1700 DIAGONAL ROAD, SUITE 300, ALEXANDRIA, VA, 22314, US

(73) Assignee: France Telecom, Paris (FR)

(21) Appl. No.: 11/955,493

(22) Filed: Dec. 13, 2007

(30) Foreign Application Priority Data
Dec. 22, 2006 (FR) 0655868

(51) Int. Cl. G06F 12/02; G06F 17/30

(52) U.S. Cl. 707/205; 707/E17.001

(57) ABSTRACT

A data processing system for constructing a co-occurrence data file relating to a corpus of objects comprises first memory and second memory. A module determines the size of the co-occurrence data file from an inventory of distinct objects in the corpus. A second module divides the size of the co-occurrence data file into blocks occupying a memory space at most equal to the size of a buffer block of the first memory, each block of the file matching inventoried objects with each other. A third module processes each block of the file by reading the corpus and incrementing by one unity a frequency count associated with objects of the block if those objects are grouped in the read corpus to satisfy a co-occurrence criterion, each group of objects corresponding to one co-occurrence data item. At the end of the reading of the corpus, the co-occurrence data and the associated non-null frequency counts corresponding to the co-occurrence data are transferred to the co-occurrence data file in the second memory.

The system constructs exhaustively from the corpus of objects a file able to contain a large volume of co-occurrence data using a storage peripheral, as the second memory of the system, to store the file and relying on a central memory of processor, as the first memory, to inventory the co-occurrence data and to update the associated frequency counts. The invention enables particularly matrix operations to data exceeding the capacity of the central memory.

### RELATED APPLICATION

The present application is based on, and claims priority from, French Application Number 0655868, filed Dec. 22, 2006, the disclosure of which is hereby incorporated by reference herein in its entirety.

### BACKGROUND OF THE INVENTION

1. Field of the Invention

The present invention relates to construction of a large co-occurrence data file from an initial corpus of objects.

The principle of co-occurrence consists in searching for the presence of a relationship between objects within an initial corpus of objects to be observed in accordance with a specific co-occurrence criterion and is applicable to diverse fields. In the linguistic field, more particularly for the automatic acquisition of semantic knowledge from text documents, the co-occurrence principle concerns the observation of word-word pair or word-document pair within a document collection, for example according to a criterion of the position of the words in the documents. In the field of biology, the co-occurrence principle encompasses observation of the presence of identical subsequences of gene, medication and cell objects within molecular sequences to identify interactions between those various objects.

2. Description of the Prior Art

The relationship of co-occurrence between objects within a corpus of objects can be binary between two objects or n-ary between n objects. In formal terms, a co-occurrence relationship is a subset of the product set Oⁿ where O is the set of the objects of the corpus and n is an integer greater than or equal to 2. In the case of a subset constructed from observations of the corpus, the co-occurrence relationship between objects can be defined only by an exhaustive inventory of all the pairs or n-tuples that constitute it. An inventory entails carrying out a series of observations of the corpus. The objects present in an observation and satisfying the co-occurrence criterion are paired into pairs or grouped into n-tuples, also referred to as co-occurrence data. Because of the possible reappearance of the same co-occurrence data in different observations, it is beneficial to weight them by a frequency count, which makes it possible thereafter, using other analysis methods, to evaluate their relative importance within the same corpus and to deduce therefrom the relationship that links them.

One example of an end application relating to the co-occurrence principle concerns an automatic training method for constructing semantic databases usable when searching documents in accordance with a specific topic.

This kind of automatic training process based on the co-occurrence principle has the advantage of simplified design compared to other automatic training approaches for constructing semantic databases. However, for high-volume applications, the major difficulty concerns the large volume of co-occurrence data to be stored. In fact, for large-scale applications, the number of objects can easily reach 1 000 000. For example, if inflected forms are taken into account, the potential vocabulary of the French language is of the order 600 000 to 700 000 forms. Adding fixed expressions and terminology, the cited figure of 1 000 000 is quickly reached.

For frequency counting a binary type co-occurrence relationship, it is potentially necessary to store 1 000 000×1 000 000 different pairs of objects. For n-ary relationships, the storage space is at least (1 000 000)ⁿ different n-tuples. Storing large quantities of data in central random access memory being technically impossible, one alternative would be to use secondary memories such as hard disks. That solution is not acceptable because of the prohibitive calculation time induced by accessing the disks during the training phase. In fact, during this phase, the co-occurrence data is not known in advance. Discovering the co-occurrence data as and when the corpus of objects is explored necessitates random access to the stored data in order to distinguish new co-occurrence data from that already inventoried, and to update the frequency count if the same co-occurrence data is observed again.

Existing solutions that circumvent this difficulty rely on simplifying hypotheses to reduce the volume of co-occurrence data in order to be able to process it in central memory. Simplification of the data is effected to the detriment of accuracy, the quality of the expected results, and the range of applications, however. Thus for applications such as categorizing documents, simplification can yield acceptable results, but for applications such as semantic indexing of documents, simplification is going to degrade indexing performance, which is dependent on the exhaustive nature, the quantity and the quality of the co-occurrence data that has been acquired.

### SUMMARY OF THE INVENTION

To remedy the drawbacks referred to above, a method according to the invention for constructing a co-occurrence data file relating to a corpus of objects in a data processing system comprising first memory and second memory is characterized in that it includes the steps of:

determining the size of the co-occurrence data file from an inventory of distinct objects in the corpus, dividing the size of the co-occurrence data file into blocks occupying a memory space at most equal to the size of a buffer block of the first memory, each block of the file matching inventoried objects with each other,

processing each block of the file by reading the corpus and incrementing by one unity a frequency count associated with objects of the block if those objects are grouped in the read corpus to satisfy a co-occurrence criterion, each group of objects corresponding to one co-occurrence data item, and

transferring the co-occurrence data and the associated non-null frequency counts corresponding to the co-occurrence data from the buffer block of the first memory to the co-occurrence data file in the second memory.

The invention constructs exhaustively from the corpus of objects a file able to contain a large volume of co-occurrence data using a storage peripheral, as the second memory of the data processing system, to store the file and relying on a central memory of processor, as the first memory, to inventory the co-occurrence data and to update the associated frequency counts. The difficulty of the volume of co-occurrence data in memory is solved by the invention by dividing the co-occurrence data file into blocks processed by the central memory and transferred once processed into the storage peripheral. The invention offers new perspectives such as the automatic construction of very large semantic networks, the application of matrix operations to data exceeding the capacity of the central memory, and the use of processing that at present cannot be used on a large scale in analysis and indexing based on semantics.

According to a first embodiment of the invention intended in particular for a high-density binary co-occurrence relationship, the co-occurrence data file is a matrix matching distinct objects from the corpus with each other, the matrix being divided into blocks of identical size at most equal to the size of the buffer block of the first memory, each block being processed in the first memory while reading the corpus of objects, and the co-occurrence data and the associated non-null frequency counts corresponding to the co-occurrence data in the processed block are transferred into the matrix.

According to a second embodiment intended in particular for a low-density binary co-occurrence relationship or an n-ary co-occurrence relationship, and the co-occurrence file is an initially null one-dimensional table, each block processed in the first memory and belonging to the one-dimensional table varies as a function of the size of the buffer block and the maximum number of co-occurrences of the corpus of objects not yet inventoried in the one-dimensional table.

According to one feature of the second embodiment, processing a block of the one-dimensional table in the buffer block includes the steps of:

dimensioning the buffer block by minimum and maximum characteristic data as a function of the number of distinct objects inventoried in the corpus of objects,

filling in as and when the corpus is read a hashing table included in the buffer block with the distinct co-occurrence data respectively associated with frequency counts, the co-occurrence data being included between the minimum and maximum characteristic data of the buffer block,

transferring all the co-occurrence data and the associated frequency counts from the hashing table to the processed block as soon as the hashing table is full, the co-occurrence data and the associated frequency counts being sorted in a specific order in the processed block,

peak limiting the processed block if the buffer block is full and redimensioning the minimum and maximum characteristic data of the buffer block as a function of the peak limiting of the processed block,

reiterating the preceding three steps until the reading of the corpus of objects is completed, and

transferring all the co-occurrence data and the associated frequency counts from the processed block in the buffer block to the one-dimensional table of the second memory at the end of reading the corpus of objects.

The invention is also directed to a data processing system comprising first memory and second memory for constructing a co-occurrence data file relating to a corpus of objects. The system is characterized in that it includes:

means for determining the size of the co-occurrence data file from an inventory of distinct objects in the corpus,

means for dividing the size of the co-occurrence data file into blocks occupying a memory space at most equal to the size of a buffer block of the first memory, each block of the file matching inventoried objects with each other,

means for processing each block of the file by reading the corpus and incrementing by one unity a frequency count associated with objects of the block if those objects are grouped in the read corpus to satisfy a co-occurrence criterion, each group of objects corresponding to one co-occurrence data item, and

means for transferring the co-occurrence data and the associated non-null frequency counts corresponding to the co-occurrence data from the buffer block of the first memory to the co-occurrence data file in the second memory.

The invention relates further to a computer program adapted to be executed in a data processing system including first memory and second memory for constructing a co-occurrence data file relating to a corpus of objects, said program being characterized in that it comprises instructions which, when the program is loaded into and executed in said data processing system, execute the steps conforming to the method according to the invention for constructing a co-occurrence data file.

Finally, the invention relates to a method for automatic reformulation of a search request in a search application, characterized in that it includes constructing a knowledge base from a co-occurrence data file constructed in accordance with the method conforming to the invention for constructing the co-occurrence data file.

### BRIEF DESCRIPTION OF THE DRAWINGS

Other features and advantages of the present invention will become more clearly apparent on reading the following description of embodiments of the invention given by way of nonlimiting example, with reference to the corresponding appended drawings, in which:

FIG. 1 is a schematic block diagram of a data processing system implementing a first embodiment of a method according to the invention for constructing a co-occurrence data file;

FIG. 2 shows a matrix serving as a co-occurrence data file in the first embodiment of the invention;

FIGS. 3 and 4 respectively show a buffer block and one of the blocks of the matrix in the first embodiment;

FIGS. 5 and 6 are successive portions of a flow chart of the first embodiment of a method of constructing a co-occurrence data file;

FIG. 7 is a block schematic of a data processing system implementing a second embodiment of a method according to the invention for constructing a co-occurrence data file;

FIG. 8 shows a hashing table of the second embodiment;

FIG. 9 shows a dichotomy table of the second embodiment; and

FIGS. 10 and 11 are successive portions of a flow chart of the second embodiment of a method for constructing co-occurrence data files.

### DESCRIPTION OF THE EMBODIMENTS

The invention is directed toward the construction of a co-occurrence data file from an exhaustive inventory of a large volume of co-occurrence data and its appearance frequencies, referred to as frequency counts, based on an initial corpus of objects and in accordance with a required co-occurrence relationship.

The co-occurrence data consists of groups of distinct objects included in the corpus of objects satisfying a required co-occurrence relationship according to a specific co-occurrence criterion.

A co-occurrence relationship is defined by two principle characteristics: the arity and the density of the relationship. The arity of a co-occurrence relationship is the binary character of the relationship expressing the pairing with each other of two objects from the corpus or more generally the n-ary character of the relationship expressing the grouping with each other of n objects from the corpus according to a specific co-occurrence criterion to form co-occurrence data. The density of the co-occurrence relationship is characterized by the number of co-occurrence data items with a non-null frequency count inventoried in the corpus of objects. The density can be high or low.

One example of a binary co-occurrence relationship of words in a corpus of linear texts concerns binary locutions such as “bowler hat” or “vacuum tube”, for which the associated co-occurrence criterion corresponds to the presence of two consecutive words in the corpus, one word being considered as an object.

One example of an n-ary co-occurrence relationship of words in a corpus of linear texts concerns expressions of the noun-preposition-noun type such as “tin of soup” or “pair of scissors”, the associated co-occurrence criterion corresponding to the presence of two words separated by a preposition in the corpus.

Another example of a co-occurrence relationship relates to non-typed semantic relationships between objects of a corpus according to a co-occurrence criterion corresponding to a two by two association of words appearing in a window of fixed size sliding from word to word in the corpus. This kind of co-occurrence relationship has a high density.

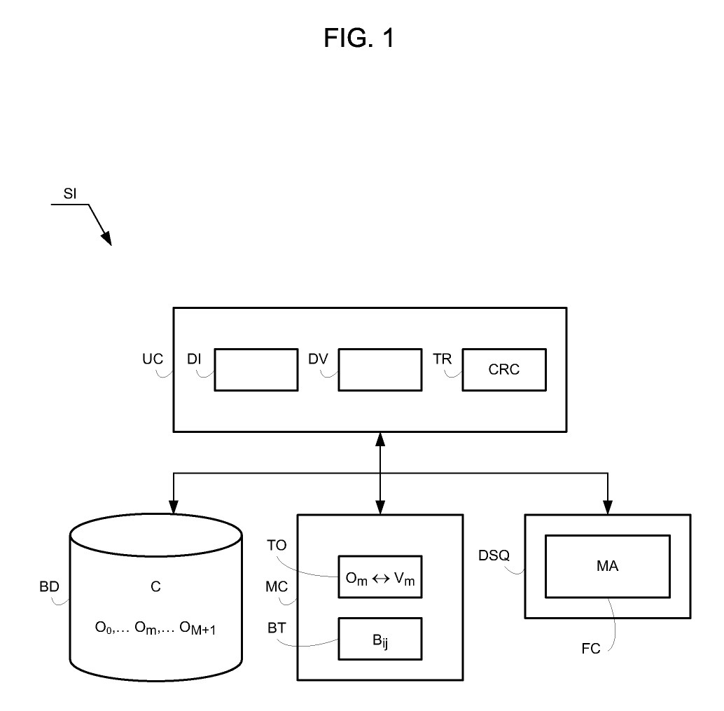

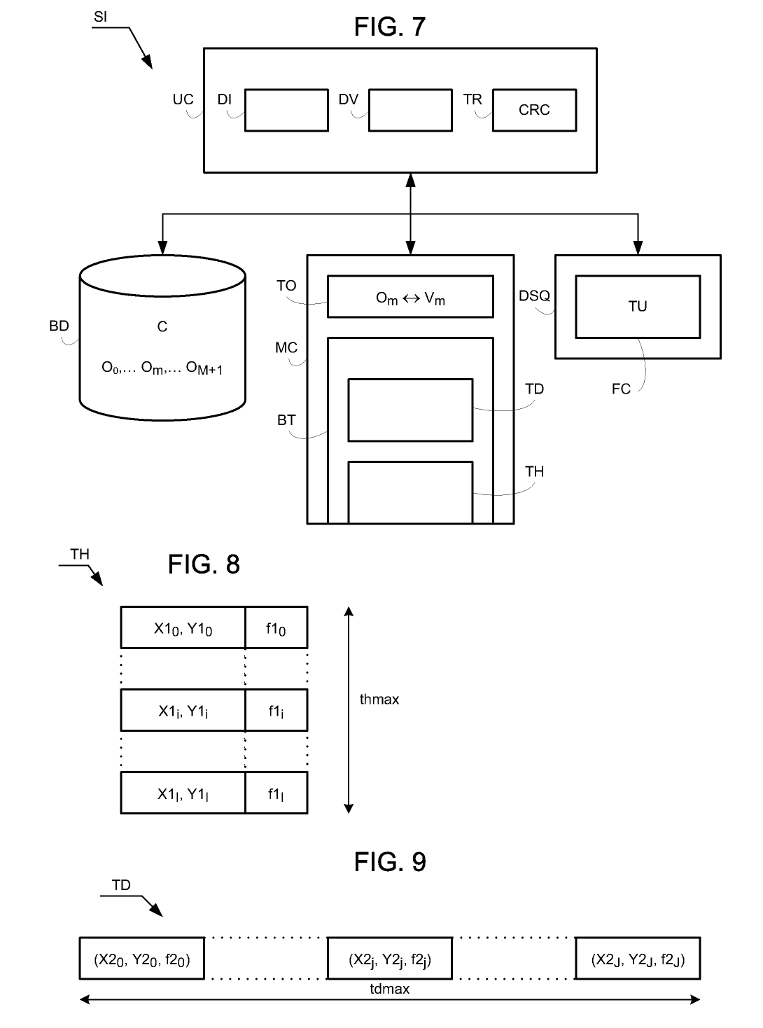

Referring to FIGS. 1 and 7, a data processing system SI implementing two embodiments of a method according to the invention of constructing a co-occurrence data file includes a central processing unit UC, such as a processor, controlling the execution of the co-occurrence data file construction method and connected by a bus to a database BD and to first and second memories MC and DSQ.

The database BD contains a corpus C of objects including a set of linear texts containing M+1 distinct word considered as objects Oₘ, the index m lying between 0 and the integer M.

The first memory is a central memory MC of the system, such as a volatile RAM memory or a non-volatile EEPROM memory. The central memory MC includes an initially empty table TO of objects for matching distinct inventoried objects Oₘ of the corpus C by the unit UC with respective integer numerical values Vₘ, for example one by one in an increasing order. The central memory MC also includes a buffer block BT for compiling an inventory of and updating the co-occurrence data extracted from the corpus C of objects and the associated frequency counts. The buffer block BT, a first embodiment of which is represented in FIG. 3, can contain only E elements and is characterized by a minimum value (minX, minY) and a maximum value (maxX, maxY).

The second memory is a storage peripheral including a storage medium such as a hard disk DSQ and having a much higher capacity than the first memory MC. Reading and writing the hard disk are discontinuous and slower than access to the central memory. The hard disk DSQ contains the initially empty co-occurrence data file FC that is not stored in the central memory MC because of its large final size. However, reading and writing the file FC on the hard disk DSQ by the central unit UC is discontinuous, which represents a very severe penalty in terms of processing time. In fact, hard disk technology favors sequential reading and writing.

To optimize the processing time, the invention divides the file FC into blocks that are successively processed one by one in the buffer block BT of the central memory MC and transferred into the file FC on the hard disk DSQ.

For constructing the co-occurrence data file FC, the central unit UC includes a dimensioning module DI, a division module DV, and a processing module TR. The module DI determines the size of the file FC during a first reading of the corpus C. The module DV divides the file FC into blocks. The module TR processes each block of the file FC in the central memory MC during a reading of the corpus C as a function of a co-occurrence criterion CRC and transfers the processed block onto the hard disk DSQ at the end of reading the corpus and before processing a subsequent block. The three modules DI, DV and TR are functional software modules described in detail hereinafter.

The co-occurrence data file FC is intended to contain all the useful inventoried co-occurrence data, i.e. the co-occurrence data respectively associated with non-null frequency counts. The storage of the co-occurrence data in the file FC and consequently the construction of the file FC depend on the required type of co-occurrence relationship. Two embodiments to construct the file FC are described hereinafter.

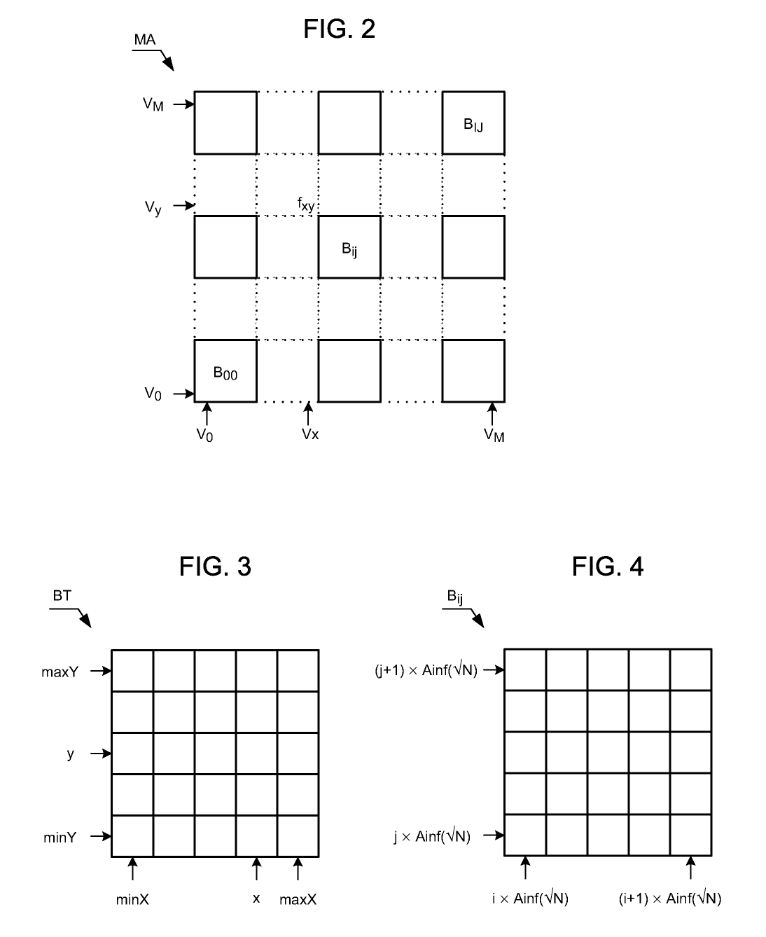

A first embodiment of constructing the file FC is particularly suited to a high-density binary co-occurrence relationship and is implemented in the data processing system represented in FIG. 1. In this first embodiment, the co-occurrence data file FC initially contains the size of a matrix MA for which the addresses of the initially null elements correspond to pairs of numerical values (Vₓ, V_{y}) of objects Oₓ, O_{y} formed progressively and subsequently when compiling an inventory of the co-occurrence data. The matrix is used to store only the co-occurrence data inventoried in the corpus C and its associated non-null frequency counts. The matrix MA is therefore “virtual” and is represented in FIG. 2 for a better understanding of the invention. The matrix MA pairs each numerical value Vₓ associated with an object Oₓ in the table TO of objects and defines in a first line, for instance a column of the matrix, with each numerical value V_{y} associated with an object O_{y} in the table TO of objects and defined in a second line, for instance a row of the matrix, with the indices x and y between 0 and M. This kind of pairing (Vₓ, V_{y}) in the matrix MA corresponds to a co-occurrence data item and the element MA[Vₓ] [V_{y}] of the pairing to the intersection of the first and second rows in the matrix MA corresponds to the associated frequency count f_{xy}. The matrix MA is formed of blocks of identical size, which size depends on the size of the buffer block BT in the central memory MC. Each square block Bᵢⱼ forming the matrix MA, with indices i and j such that 0·i·I and 0·j·J, must contain a number of elements less than or equal to the number N of elements of the buffer block BT. Accordingly, as represented in FIG. 4, each block Bᵢⱼ is characterized by a minimum value (i×Ainf(·N), j×Ainf(·N)) and a maximum value ((i+1)×Ainf(·N), (j+1)×Ainf(·N)), where Ainf is a rounding down function. A co-occurrence data item (Vₓ, V_{y}) is part of the block Bᵢⱼ if:

i×Ainf(·N)*Vₓ·(i+1)×Ainf(·N), et

j×Ainf(·N)·V_{y}·(j+1)×Ainf(·N).

From the above relationships, it can be deduced that I=J=Asup((M+1)/·N), where Asup is a rounding up function.

The buffer block BT illustrated in FIG. 3 in a two-dimensional representation corresponding to the rows y and the columns x is stored in the central memory in a one-dimensional representation. The buffer block is therefore accessed column by column, each column x of the block being identified by its index and including a list of maxY pairs, each consisting of the index of the row y and the frequency count associated with the co-occurrence data item (x, y).

The matrix MA is stored partly on the hard disk DSQ in a one-dimensional representation. At the end of processing a block Bᵢⱼ in the central memory MC, only the co-occurrence data inventoried and the associated non-null frequency counts in the processed block Bᵢⱼ are stored contiguously column by column in the matrix MA, co-occurrence data associated with null frequency counts not being stored.

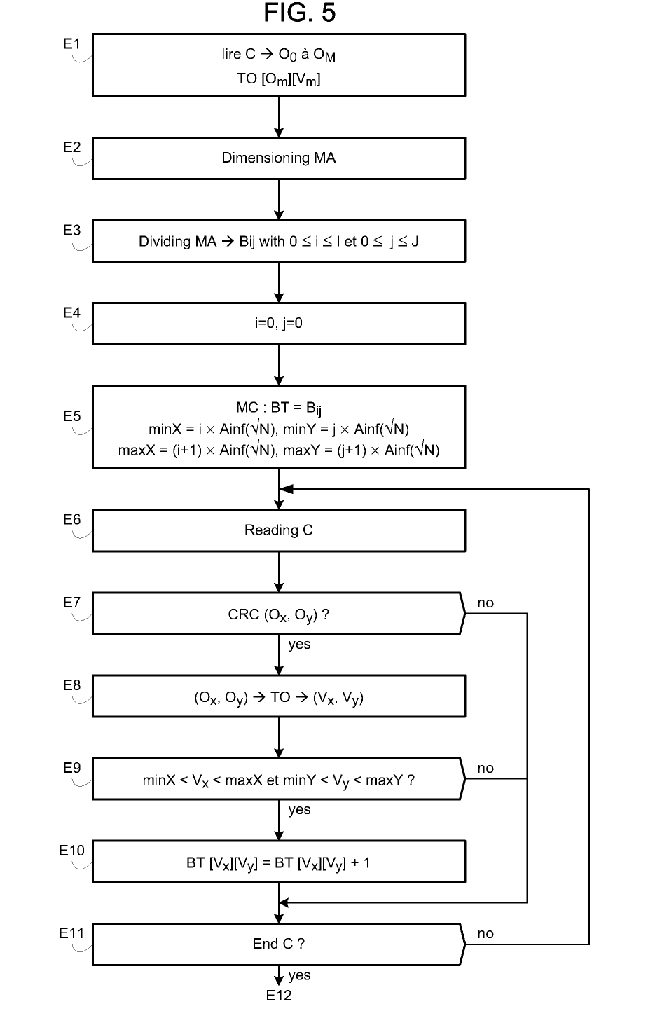

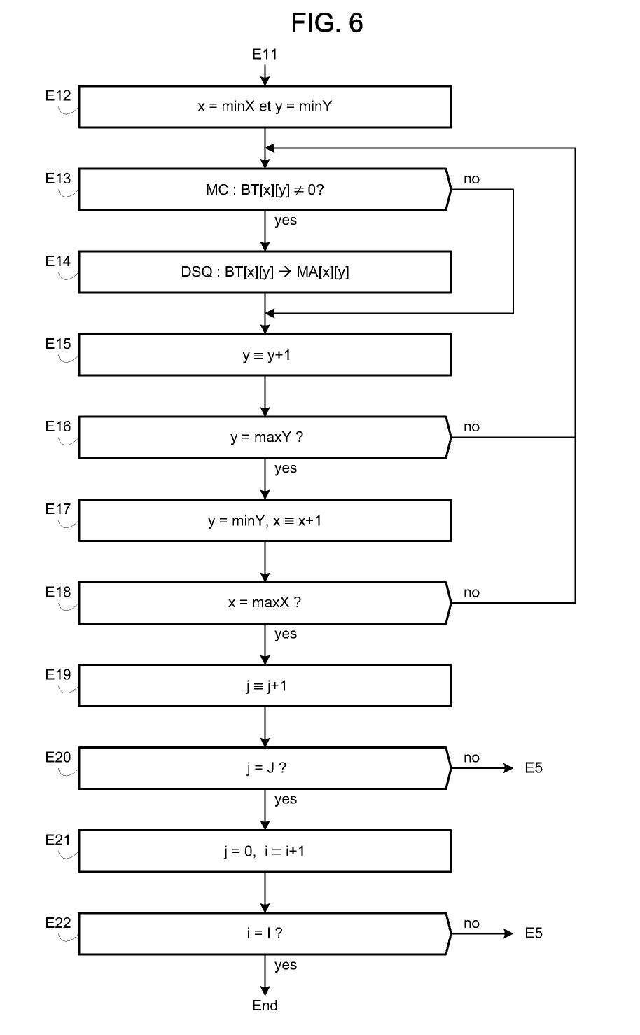

The method in accordance with the first embodiment of the invention of constructing a matrix MA as a co-occurrence data file FC comprises steps E1 to E22 represented in FIGS. 5 and 6.

In the step E1, the dimensioning module DI reads the corpus C of objects and draws up an inventory of M+1 distinct objects O₀ to O_{M}. For example, in the corpus containing linear texts, the module DI isolates and extracts each word-object of the text relative to word separators such as spaces and punctuation signs. As the inventory proceeds, each object Oₘ extracted from the corpus is inserted into the table TO of objects of the central memory MC and is associated with an integer numerical value Vₘ, where Vₘ₋₁<Vₘ<Vₘ₊₁ and 0<m≦M+1. At the end of the first reading of the corpus C, in the step E2, the module DI dimensions the matrix MA on the hard disk DSQ as a function of the number M+1 of objects inventoried previously, the maximum size of the matrix being (M+1)×(M+1) elements.

In the step E3, the division module DV of the central unit UC divides the size of the matrix MA previously dimensioned into I×J blocks Bᵢⱼ of identical size as a function of the size N of the buffer block BT of the central memory MC.

After setting i and j to zero in the step E4, the processing module TR executes in the step E5 a bijection from a first block Bᵢⱼ=B₀₀ of the matrix MA to the buffer block BT. The bijection is defined by the minimum value (minX, minY) of the buffer block BT equal to the minimum value (i×Ainf(vN), j×Ainf(vN)) of the block Bᵢⱼ and the maximum value (maxX, maxY) of the buffer block BT equal to the maximum value ((i+1)×Ainf(·N), (j+1)×Ainf(·N)) of the block Bᵢⱼ. The processing module TR then processes the block Bᵢⱼ in the memory MC.

In the step E6, the module TR launches reading of the corpus C, for example by initializing an observation window of fixed size containing first successive objects of the corpus and intended to be moved from one object to the next in the corpus on each observation of the corpus in order for the module TR to seek to associate each first object from the window with the other objects from said window. If in the step E7 no association of objects in the observation window satisfies the co-occurrence criterion CRC, the processing module TR verifies in the step E11 that reading has reached the end of the corpus.

If not, the module TR continues to read the corpus C, in the step E7, shifting the observation window by one object in the corpus. If in the step E7 a pair of objects Oₓ, O_{y} in the observation window satisfies the co-occurrence criterion CRC, the processing module TR extracts both objects Oₓ and O_{y} and recovers in the table TO of objects the numerical values Vₓ and V_{y} associated with those objects in the step E8. In the step E9, the processing module TR verifies if the two values Vₓ and V_{y} are included in the block BT. If minX=Vₓ=maxX and minY=V_{y}=maxY, then the value BT[Vx] [Vy] corresponding to the frequency count f_{xy} associated with the co-occurrence data item (Vₓ, V_{y}) in the buffer block BT is incremented by one unity in the step E10. In the step E11, the processing module TR continues the analysis of the observation window or, if the entire window has been analyzed, the module TR continues the reading of the corpus C. Until the entire corpus C has been read, the processing module TR slides the observation window from one object to the next in the corpus and executes the steps E6 to E11.

Once the corpus C has been entirely read by the module TR, the latter transfers the non-null elements of the block Bᵢⱼ processed in the block BT, contiguous in the matrix MA on the hard disk DSQ, in the steps E12 to E18. Two pointers x and y of the buffer block BT are respectively moved from the values minX and minY to the values maxX and maxY in order to scan all the elements of the block BT. In the step E13, if the content of the element BT[x] [y] is not null, it is stored in the matrix MA associated with the addresses (x, y)=(Vₓ, V_{y}) in the step E14. Thus only co-occurrence data for which the associated frequency counts are non-null are stored in the file FC on the hard disk DSQ. After each execution of the steps E13 and E14, the processing module TR increments the pointer y by one unity in the step E15 provided that it did not reach maxY in the step E16. Then, in the step E17, the pointer y is reinitialized to minY and the pointer x is incremented by one unity. The steps E13 to E17 are repeated until the pointer x reaches the value maxX in the step E18.

As soon as the non-null content of the block BT has been transferred entirely to the matrix MA on the hard disk DSQ, in the step E18, the processing module TR empties the buffer block BT and effects a new bijection from a subsequent block Bᵢ₍ⱼ₊₁₎ to the block BT, in the step E5. For block to block processing, the processing module TR increments the index j by one unity in the step E19 until the index j reaches J in the step E20, reinitializes the index j to zero, and increments the index i by one unity in the step E21 provided that the index i has not reached I in the step E22.

The steps E5 to E22 are executed until all the blocks Bᵢⱼ forming the matrix MA have been processed, with the indices i and j respectively between 0 and I and between 0 and J. On each complete reading of the corpus C, a block forming the matrix MA is processed in the memory MC by the module TR.

A second embodiment of constructing the co-occurrence data file FC is particularly suited to a low-density binary co-occurrence relationship or an n-ary co-occurrence relationship, and is implemented in the data processing system represented in FIG. 7.

In this second embodiment, the co-occurrence data file FC is a one-dimensional table TU in which each co-occurrence data item is stored in the form of a numerical index associated with an associated frequency count.

In a low-density binary co-occurrence relationship, the table TU stores triplets (Xᵤ, Yᵤ, fᵤ) for which the index u is between 0 and an integer U, and the integer U is variable and initially null. (X₀, Y₀), . . . (Xᵤ, Yᵤ), . . . (X_{U}, Y_{U}) constitute the co-occurrence data and f₀, . . . fᵤ, . . . f_{U} constitute the associated frequency count. The triplets (Xᵤ, Yᵤ, fᵤ) are stored contiguously and in a manner ordered by a total order relationship in the table TU. This total order relationship is defined so that, for two triplets (XAᵤ, YAᵤ, fAᵤ) and (XBᵤ, YBᵤ, fBᵤ):

(XAᵤ,YAᵤ,fAᵤ)<(XBᵤ,YBᵤ, fBᵤ) if:

XAᵤ<XBᵤ where

XAᵤ=XBᵤ and YAᵤ<YBᵤ, and

(XAᵤ,YAᵤ,fAᵤ)=(XBᵤ,YBᵤ,fBᵤ) if:

XAᵤ=XBᵤ and YAᵤ=YBᵤ.

The one-dimensional table TU stored on the hard disk DSQ is considered as an initially empty dichotomy table which expands as the reading of the corpus proceeds through the insertion of new co-occurrence data associated with non-null frequency counts, (M+1)×(M+1) elements being the maximum size of the table TU. The memory space of the central memory MC being too limited to store all the co-occurrence data simultaneously, the table TU is divided, as the inventory of the co-occurrence data proceeds, into one or more blocks of variable size processed in the buffer block BT of the central memory. The characteristic values minX, minY, maxX and maxY of the buffer block BT, initially at 0, vary during reading of the corpus C. At the end of each reading of the corpus, the characteristic values of the variable block processed in the central memory MC correspond to the characteristic values of the block BT.

The buffer block BT shown in FIG. 7 comprises a dichotomy table TD corresponding to the variable block processed, and a hashing table TH.

Referring to FIG. 8, as and when it is inventoried, the co-occurrence data (X1ᵢ, Y1ᵢ), with the index i such that 0·i·I and I being an initially null variable integer, are inserted into the hashing table TH one after the other. The co-occurrence data (X1ᵢ, Y1ᵢ) is considered as an access key to the associated frequency counts f1ᵢ updated on each observation of said data (X1ᵢ, Y1ᵢ) in the corpus C. The maximum size of the hashing table is thmax and is less than the size of the buffer block. As soon as the hashing table is full, the co-occurrence data (X1ᵢ, Y1ᵢ) and its associated frequency counts f1ⱼ are transferred into the dichotomy table TD.

As shown in FIG. 9, the dichotomy table TD contains triplets (X2ⱼ, Y2ⱼ, f2ⱼ), where the index j is such that 0·j·J and J is an initially null variable integer. X2₀, Y2₀, . . . X2ⱼ, Y2ⱼ, . . . X2_{J}, Y2_{J} constitute co-occurrence data and f2₀, . . . f2ⱼ, . . . f2ⱼ are their associated frequency counts coming from the hashing table TH. The triplets (X2ⱼ, Y2ⱼ, f2ⱼ) are ordered in accordance with the total order relationship described hereinabove. The maximum size of the dichotomy table TD is tdmax and is equal to the size of the buffer block BT and larger than the maximum size of the hashing table TH. Once the entire corpus C has been read, the dichotomy table TD corresponds to the processed variable block from the table TU with characteristic values minX=X2₀, minY=Y2₀, maxX=X2_{J-1}, maxY=Y2_{J-1} of the buffer block BT, the triplets (X2ⱼ, Y2ⱼ, f2ⱼ) such that 0·j·J−1 are transferred in the same order into the one-dimensional table TU of the hard disk DSQ. During further reading of the corpus C, a new block from the table TU is then processed in the buffer block BT having new characteristic values minX=X2_{J}, minY=Y2_{J}, maxX=M+1 and maxY=M+1.

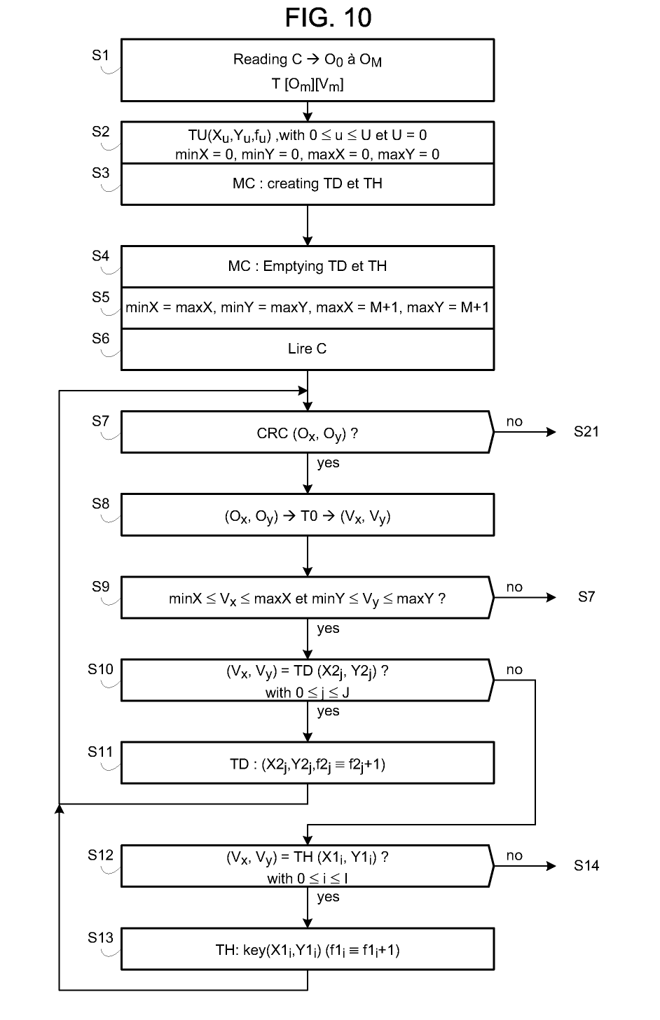

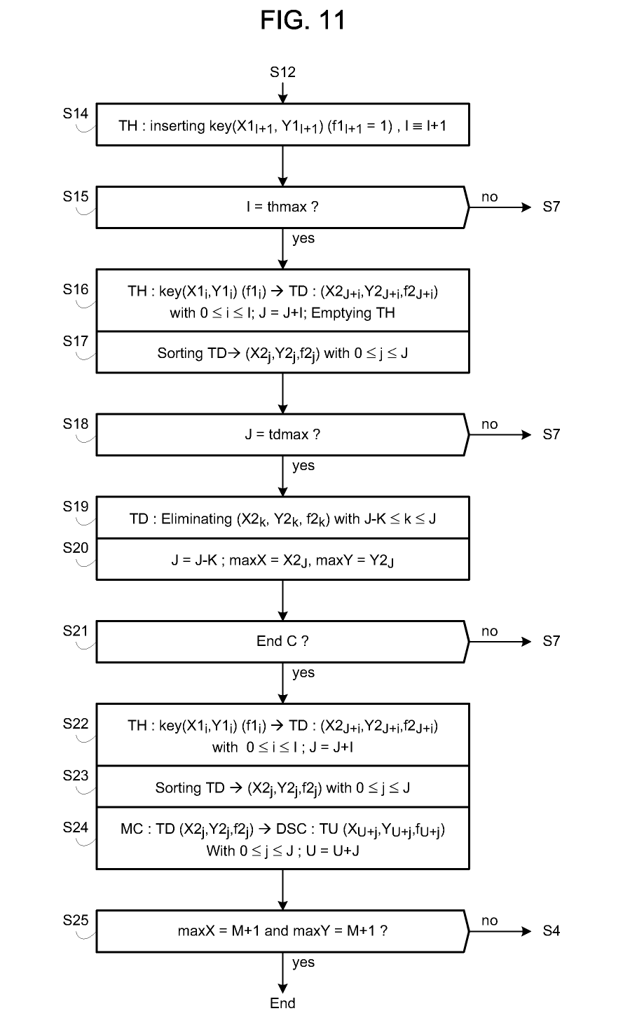

The second embodiment of the method according to the invention of constructing a one-dimensional table TU as a co-occurrence data file FC comprises steps S1 to S25 represented in FIGS. 10 and 11.

The step S1 is analogous to the step E1 of FIG. 5 relating to the first embodiment, during which the dimensioning module DI reads the corpus C of objects and draws up an inventory of M+1 distinct object O₀ to O_{M}. Each object Oₘ extracted from the corpus is inserted into the table TO of objects of the central memory MC and is associated with an integer numerical value Vₘ.

At the end of the first reading of the corpus C, in the step S2, the module DI dimensions the one-dimensional table TU on the hard disk DSQ as a function of the number M+1 of objects previously inventoried, the maximum size of the table TU being (M+1)×(M+1) initially null elements. In the step S2, the division module DV initializes to zero the characteristic values minX, minY, maxX and maxY of the buffer block BT of the central memory MC.

In the step S3, the processing module TR creates in the buffer block BT the dichotomy table TD and the hashing table TH, which are initially empty. Alternatively, the tables TD and TH are already created in the buffer block BT.

In the step S4, the processing module TR empties the tables TD and TH if they previously contained co-occurrence data and associated frequency counts, inventoried during an earlier reading of the corpus C.

In the step S5, the module DI of the central unit dimensions the buffer block BT of the central memory MC to the characteristic values minX=maxX, minY=maxY, maxX=M+1 and maxY=M+1. During a first reading of the corpus C, the values minX and minY are null values.

In the step S6, the module TR launches the reading of the corpus C, for example by initializing an observation window of fixed size containing a first P successive objects of the corpus and intended to be shifted from one object in the corpus to the next on each observation of the corpus in order for the module TR to seek to associate each first object from the window with the other objects from said window. If in the step S7 no association of objects in the observation window satisfies the co-occurrence criterion CRC, the processing module TR verifies the end of reading of the corpus in the step S21.

If the reading of the corpus has not finished in the step E21, the module TR continues to read the corpus C, in the step S7, shifting the observation window one object in the corpus. If in the step S7 a pair of objects Oₓ, O_{y} in the observation window satisfies the co-occurrence criterion CRC, the processing module TR extracts the two objects Oₓ and O_{y} and recovers in the table TO of objects the associated numerical values Vₓ and V_{y} in the step S8. In the step S9, the processing module TR verifies whether the two values Vₓ and V_{y} lie between the characteristic values of the block BT. If the values Vₓ and V_{y} do not lie between the characteristic values of the block BT, the module TR continues the analysis of the observation window in the step S7. On the other hand, in the step S9, if minX·Vₓ·maxX and minY·V_{y}·maxY, the module TR verifies whether the co-occurrence data item (Vₓ, V_{y}) is present in the dichotomy table TD in the buffer block BT in the step S10. To this end, the processing module TR compares the values Vₓ and V_{y} to each co-occurrence data item (X2ⱼ, Y2ⱼ) stored in the table TD, with 0=j=J. If Vₓ=X2ⱼ and V_{y}=Y2ⱼ, then the frequency count f2ⱼ associated with the data item (X2ⱼ, Y2ⱼ) is incremented by one unity in the step S11.

In the step S10, if the co-occurrence data item (Vₓ, V_{y}) is absent from the table TD, the module TR verifies whether said data item (Vₓ, V_{y}) is present in the hashing table TH in the step S12. To this end, the module TR compares the values Vₓ and V_{y} to each access key (X1ᵢ, Y1ᵢ) stored in the table TH, with 0·i·I. If Vₓ=X1ᵢ and V_{y}=Y1ᵢ, then the frequency count f1ᵢ associated with the access key (X1ᵢ, Y1ᵢ) is incremented by one unity in the step S13.

In the step S12, if the co-occurrence data item (Vₓ, V_{y}) is not present in the table TH, the processing module TR of the central unit UC inserts at the end of the table TH a new access key (X1_{I+1}, Y1_{I+1}), where X1_{I+1}=Vₓ and Y1_{I+1}=V_{y}, associated with a frequency count f1_{I+1} of value 1, in the step S14. The current size I of the table TH is then incremented by one unity.

In the step S15, the module TR verifies whether the hashing table is full. If the current size I of the table TH is not equal to the maximum size thmax of the table TH, the module TR continues the reading of the corpus in the step S7. In the contrary situation, the module TR transfers from the hashing table TH each key (X1ᵢ, Y1ᵢ) and the associated frequency count f1ᵢ, for i between 0 and I, into a new triplet (X2_{J+i}, Y2_{J+i}, f2_{J+i}) inserted at the end of the dichotomy table TD in the step S16. At the end of the step S16, the current size J of the table TD is incremented by the value I, after which the module TR empties the hashing table TH, which corresponds to a null value of I.

In the step S17, the module TR sorts the dichotomy table TD according to the total order defined above.

In the step S18, the module TR verifies whether the dichotomy table TD is full. If the current size J of the table TD is not equal to the maximum size tdmax of the table TD, the module TR continues the analysis of the corpus in the step S7. In the contrary situation, the module TR peak limits the dichotomy table by eliminating the last K triplets (X2ₖ, Y2ₖ, f2ₖ) from the dichotomy table TD in the step S19, for k between J−K and J. The value K is judiciously chosen to avoid a second peak limiting of a dichotomy table before the end of the reading of the corpus C and to prevent excessive elimination of triplets whose processing time corresponds to wasted processing time. For example, the value K can correspond to thirty percent of the size of the dichotomy table.

In the step S20, the size J is decremented by the value K and the dimensioning module DI modifies the maximum characteristic values of the buffer block BT, which are equal to the numerical values X2_{J} and Y2_{J} of the last triplet from the peak-limited table TD. Thus, if the reading of the corpus C has not finished, in the step E21, only the co-occurrence data (Vₓ, Y_{y}) inventoried during the remainder of the reading of the corpus C, with Vₓ<maxX and V_{y}<maxY, is analyzed in the buffer block BT in the steps S14 to S20. Further peak limiting of the dichotomy table can occur if the dichotomy table TD is full again, the maximum characteristic values maxX and maxY are modified again as a function of the peak limiting of the dichotomy table.

Until the reading of the corpus C has finished, the modules TR and DI execute the steps S7 to S21. As soon as the reading of the corpus C has ended, in the step S22, the module TR transfers from the hashing table TH each key (X1ᵢ, Y1ᵢ) and the associated frequency count f1ᵢ, for between 0 and I, into a new triplet (X2_{J+i}, Y2_{J+i}, f2_{J+i}) inserted at the end of the dichotomy table TD. At the end of the step S22, the size J of the table TD is incremented by the value I. In the step S23, the module TR sorts the dichotomy table TD in accordance with the total order defined above.

In the step S24, the module TR transfers from the dichotomy table TD each triplet (X2ⱼ, Y2ⱼ, f2ⱼ) and the associated frequency count f2ⱼ, for j between 0 and J, into a new triplet (X_{U+j}, Y_{U+j}, f_{U+j}) inserted at the end of the one-dimensional table TU on the hard disk DSQ. The size U of the table TU is then incremented by the value J.

In the step S25, the module TR verifies whether all the co-occurrence data from the corpus C has been inventoried by comparing the maximum values of the buffer block BT to the total number M+1 of objects present in the corpus. If maxX and maxY are respectively equal to the value M+1, then the reading of the corpus C has finished. In the contrary situation, in the steps S4 and S6, the processing module TR empties the tables TD and TH, with J=0 and I=0, and the dimensioning module DI redimensions the buffer block BT to the characteristic values minX=maxX, minY=maxY, maxX=M+1 and maxY=M+1, in order to process a new block of the one-dimensional table TU.

At the end of reading the corpus, only the co-occurrence data associated with a non-null frequency count is inventoried in the one-dimensional table TU.

Alternatively, in the case of a co-occurrence relationship of variable arity, the system and the method are substantially analogous to the second embodiment of the invention and the co-occurrence data file still corresponds to a one-dimensional table. However, to change the variable arity relationship to a fixed arity relationship, the set of objects grouped in a co-occurrence data item is enlarged with undefined new elements “indf”. Thus if n is the maximum arity of the relationship, then any p-tuple (X₁, X₂, . . . , Xₚ) representing a co-occurrence data item inventoried in accordance with a p-ary relationship with p<n can be represented by an n-tuple such that:

(X₁,X₂, . . . , Xₚ,Xₚ₊₁=indf,Xₚ₊₂=indf, . . . , Xₙ=indf)

The total order relationship between n-tuples is defined for two n-tuples (X1₁, X1₂, . . . X1ₙ, f1ₙ) and (X2₁, X2₂, . . . , X2ₙ, f2ₙ) by:

(X1₁,X1₂, . . . , X1ₙ,f1ₙ)<(X2₁,X2₂, . . . , X2ₙ,f2ₙ)

if there exists p·n such that for any i<p,
X1ᵢ=X2ᵢ and
X1ₚ<X2ₚ where X1ₚ=indf and X2ₚ≠indf.

The algorithm of the second embodiment remains the same except for the replacement of the pairs forming the co-occurrence data with n-tuples.

A co-occurrence file of this type constructed by the method of the invention is particularly suitable for constructing knowledge bases, whether linguistic or semantic. These knowledge bases can be used non-exhaustively in a method of reformulating search requests in a search engine. These knowledge bases can also be used for indexing documents, for producing abstracts of documents automatically, or for categorizing documents, i.e. for classifying documents under various headings.

The invention described here relates to a method and a data processing system for constructing a co-occurrence data file. In a preferred embodiment, the steps of the method are determined by the instructions of a program included in the memory of the data processing system such as a data server or a computer. When the program is loaded into and executed in the data processing system, the instructions of the program execute the steps of the method according to the invention.

Consequently, the invention applies equally to a computer program, in particular a computer program on or in an information medium, adapted to implement the invention. That program can use any programming language, and be in the form of source code, object code or an intermediate code between source code and object code, such as in a partially compiled form, or in any other form desirable for implementing the method according to the invention.

The information medium can be any entity or device capable of storing the program. For example, the support can include storage means, such as a ROM, for example a CD-ROM or a microelectronic circuit ROM, or a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

What I claim is:

1. A method for constructing a co-occurrence data file relating to a corpus of objects in a data processing system comprising first memory and second memory, said method including the steps of:
determining the size of said co-occurrence data file from an inventory of distinct objects in said corpus,
dividing said size of said co-occurrence data file into blocks occupying a memory space at most equal to the size of a buffer block of said first memory, each block of said file matching inventoried objects with each other,
processing each block of said file by reading said corpus and incrementing by one unity a frequency count associated with objects of said each block if those objects are grouped in the read corpus to satisfy a co-occurrence criterion, each group of objects corresponding to one co-occurrence data item, and
transferring said co-occurrence data and said associated non-null frequency counts corresponding to said co-occurrence data from said buffer block of said first memory to said co-occurrence data file in said second memory.

2. A method according to claim 1, wherein said co-occurrence data file is a matrix matching distinct objects from said corpus with each other, said matrix being divided into blocks of identical size at most equal to the size of said buffer block of said first memory, each block being processed in said first memory while reading said corpus of objects, and said co-occurrence data and said associated non-null frequency counts corresponding to said co-occurrence data in the processed block are transferred into said matrix.

3. A method according to claim 1, wherein said co-occurrence file is an initially null one-dimensional table, and each block processed in said first memory and belonging to said one-dimensional table varies as a function of the size of said buffer block and the maximum number of co-occurrences of said corpus of objects not yet inventoried in said one-dimensional table.

4. A method according to claim 3, wherein processing a block of the one-dimensional table in the buffer block includes the steps of:
dimensioning said buffer block by minimum and maximum characteristic data as a function of the number of distinct objects inventoried in said corpus of objects,
filling in as and when said corpus is read a hashing table included in said buffer block with the distinct co-occurrence data respectively associated with frequency counts, said co-occurrence data being included between said minimum and maximum characteristic data of the buffer block,
transferring all said co-occurrence data and said associated frequency counts from said hashing table to the processed block as soon as said hashing table is full, said co-occurrence data and said associated frequency counts being sorted in a specific order in said processed block,
peak limiting said processed block if the buffer block is full and redimensioning said minimum and maximum characteristic data of said buffer block as a function of the peak limiting of said processed block,
reiterating the preceding three steps until the reading of the corpus of objects is completed, and
transferring all said co-occurrence data and said associated frequency counts from said processed block in said buffer block to said one-dimensional table of said second memory at the end of reading said corpus of objects.

5. A method according to claim 1, wherein determining the size of said co-occurrence data file includes inventorying all the distinct objects following a first reading of said corpus, and inserting each inventoried object into a table of objects included in said first memory and matching each distinct object to a numerical value.

6. A data processing system comprising first memory and second memory for constructing a co-occurrence data file relating to a corpus of objects, including:
means for determining said size of the co-occurrence data file from an inventory of distinct objects in said corpus,
means for dividing said size of said co-occurrence data file into blocks occupying a memory space at most equal to the size of a buffer block of said first memory, each block of said file matching inventoried objects with each other,
means for processing each block of said file by reading said corpus and incrementing by one unity a frequency count associated with objects of said each block if those objects are grouped in the read corpus to satisfy a co-occurrence criterion, each group of objects corresponding to one co-occurrence data item, and
means for transferring said co-occurrence data and said associated non-null frequency counts corresponding to said co-occurrence data from said buffer block of said first memory to said co-occurrence data file in said second memory.

7. A data processing system according to claim 6, wherein said first memory is a central memory of processor and said second memory is a storage peripheral.

8. A computer arrangement performed in a data processing system including first memory and second memory, said computer arrangement being adapted to construct a co-occurrence data file relating to a corpus of objects, said computer arrangement including instructions executing the following steps:
determining the size of said co-occurrence data file from an inventory of distinct objects in said corpus,
dividing said size of said co-occurrence data file into blocks occupying a memory space at most equal to the size of a buffer block of said first memory, each block of said file matching inventoried objects with each other,
processing each block of said file by reading said corpus and incrementing by one unity a frequency count associated with objects of said each block if those objects are grouped in the read corpus to satisfy a co-occurrence criterion, each group of objects corresponding to one co-occurrence data item, and
transferring said co-occurrence data and said associated non-null frequency counts corresponding to said co-occurrence data from said buffer block of said first memory to said co-occurrence data file in said second memory.

9. A method for automatic reformulation of a search request in a search application, including constructing a knowledge base from a co-occurrence data file constructed in accordance with a file constructing method,
said file constructing method for constructing said co-occurrence data file relating to a corpus of objects in a data processing system comprising first memory and second memory, including the steps of:
determining the size of said co-occurrence data file from an inventory of distinct objects in said corpus,
dividing said size of said co-occurrence data file into blocks occupying a memory space at most equal to the size of a buffer block of said first memory, each block of said file matching inventoried objects with each other,
processing each block of said file by reading said corpus and incrementing by one unity a frequency count associated with objects of said each block if those objects are grouped in the read corpus to satisfy a co-occurrence criterion, each group of objects corresponding to one co-occurrence data item, and
transferring said co-occurrence data and said associated non-null frequency counts corresponding to said co-occurrence data from said buffer block of said first memory to said co-occurrence data file in said second memory.
